(19) United States
(12) Patent Application Publication
(10) Pub. No.: US 2019/0327404 A1
(43) Pub. Date: Oct. 24, 2019

(54) HIGH-RESOLUTION ACTIVE IMAGE DATA GENERATING APPARATUS HAVING DIFFRACTIVE OPTICAL ELEMENT UNIT

(71) Applicant: STANLEY ELECTRIC CO., LTD., Tokyo (JP)

(72) Inventor: Yusuke YATA, Tokyo-to (JP)

(73) Assignee: STANLEY ELECTRIC CO., LTD., Tokyo (JP)

(21) Appl. No.: 16/385,930

(22) Filed: Apr. 16, 2019

(30) Foreign Application Priority Data
Apr. 20, 2018 (JP) 2018-081710

(51) Int. Cl. H04N 5/235; G06T 7/521; H04N 5/225; H04N 5/232

(52) U.S. Cl. CPC H04N 5/2352; G06T 7/521; H04N 5/23232; H04N 5/2354; H04N 5/2353; H04N 5/2254

(57) ABSTRACT

An active image data generating apparatus includes a light emitting unit adapted to emit irradiation light, an image device having multiple pixels, and a diffractive optical element unit adapted to receive the irradiation light from the light emitting unit to generate multiple irradiation patterns toward an image area. The image area is divided into multiple image regions each corresponding to one of the multiple pixels. Each of the image regions is divided into multiple sub image regions. The sub image regions located at same positions within the image regions are defined as one of sub image region groups. A control unit time-divisionally irradiates the sub image region groups with the irradiation patterns to fetch multiple sub frame data from all the pixels of the image device, and to compose the multiple sub frame data into frame data of the image area.

This application claims the priority benefit under 35 U.S.C. § 119 to Japanese Patent Application No. JP2018-081710 filed on Apr. 20, 2018, which disclosure is hereby incorporated in its entirety by reference.

### BACKGROUND

### Field

The presently disclosed subject matter relates to a high-resolution active image data generating apparatus.

### Description of the Related Art

A prior art active image data generating apparatus is constructed by a light source for irradiating an image region with light and an image device for receiving light reflected from an object in the image region. In this case, the image device includes multiple photosensing elements or photodiodes each defining one pixel (see: JP2008-896386A). In order to enhance the resolution, one approach is to increase the size of the image device without changing the size of each of the pixels, thus increasing the number of pixels. In this case, however, since the image device is increased in size, the manufacturing yield of image devices would be decreased to increase the manufacturing cost of the active image data generating apparatus.

Also, in order to enhance the resolution, another approach is to decrease the size of the pixels without changing the size of the image device, increasing the number of pixels. In this case, however, since the amount of light received by each of the pixels is decreased, the signal-to-noise (S/N) ratio would be decreased.

### SUMMARY

The presently disclosed subject matter seeks to solve one or more of the above-described problems.

According to the presently disclosed subject matter, an active image data generating apparatus includes a light emitting unit adapted to emit irradiation light, an image device having multiple pixels, and a diffractive optical element unit adapted to receive the irradiation light from the light emitting unit to generate multiple irradiation patterns toward an image area. The image area is divided into multiple image regions each corresponding to one of the multiple pixels. Each of the image regions is further divided into multiple sub image regions. The sub image regions located at same positions within the image regions are defined as one of multiple sub image region groups. A control unit is adapted to operate the light emitting unit and the image device to time-divisionally irradiate the sub image region groups with the irradiation patterns, to fetch multiple sub frame data from all the pixels of the image device, and to compose the multiple sub frame data into frame data of the image area.

According to the presently disclosed subject matter, since the amount of frame data of the image area is substantially larger than the amount of pixel data of the image device, the resolution can be enhanced.

### BRIEF DESCRIPTION OF THE DRAWINGS

The above and other advantages and features of the presently disclosed subject matter will be more apparent from the following description of certain embodiments, taken in conjunction with the accompanying drawings, as compared with the prior art, wherein:

FIG. 1 is a diagram illustrating a first embodiment of the active image data generating apparatus according to the presently disclosed subject matter;

FIG. 2 is a top view of the active image data generating apparatus of FIG. 1;

FIG. 3 is a top view of the diffractive optical element (DOE) unit of FIG. 1;

FIG. 4A is a diagram illustrating a first irradiation pattern formed on the imaginary screen of FIG. 1;

FIG. 4B is a diagram illustrating a second irradiation pattern formed on the imaginary screen of FIG. 1;

FIG. 4C is a diagram illustrating a third irradiation pattern formed on the imaginary screen of FIG. 1;

FIG. 4D is a diagram illustrating a fourth irradiation pattern formed on the imaginary screen of FIG. 1;

FIG. 5 is a detailed block circuit diagram of the image device of FIG. 1;

FIG. 6 is a flowchart for explaining the operation of the control unit of FIG. 1;

FIG. 7 is a timing diagram for explaining the flowchart of FIG. 6;

FIGS. 8A, 9A, 10A and 11A are diagrams of irradiation patterns on the imaginary screen at steps 601, 605, 609 and 613, respectively, of FIG. 6;

FIGS. 8B, 9B, 10B and 11B are diagrams of the sub frame data at steps 604, 608, 612 and 616, respectively, of FIG. 6;

FIG. 12A is a diagram of the composed irradiation patterns on the imaginary screen at step 617 of FIG. 6;

FIG. 12B is a diagram of the composed sub frame data obtained at step 617 of FIG. 6;

FIG. 13A is a diagram of an irradiation pattern on the imaginary screen of the prior art image data generating apparatus;

FIG. 13B is a diagram of the frame data obtained by the prior art image data generating apparatus;

FIG. 14 is a flowchart illustrating a modification of the flowchart of FIG. 6;

FIG. 15 is a timing diagram for explaining the flowchart of FIG. 14;

FIG. 16A is a diagram of the non-irradiated imaginary screen at step 1401 of FIG. 14;

FIG. 16B is a diagram of the frame data at step 1401 of FIG. 14;

FIG. 17 is a detailed block circuit diagram illustrating a first modification of the control unit of FIG. 1;

FIGS. 18A, 18B, 18C, 18D, 18E and 18F are timing diagrams for explaining the operation of the control unit of FIG. 17;

FIG. 19 is a detailed block circuit diagram illustrating a second modification of the control unit of FIG. 1;

FIGS. 20A, 20B, 20C, 20D, 20E, 20F, 20G and 20H are timing diagrams for explaining the operation of the control unit of FIG. 19;

FIG. 21 is a diagram illustrating a modification of composed irradiation patterns on the imaginary screen of FIG. 1;

FIG. 22 is a diagram illustrating a second embodiment of the active image data generating apparatus according to the presently disclosed subject matter;

FIG. 23 is a top view of the active image data generating apparatus of FIG. 22;

FIG. 24 is a top view of the diffractive optical element (DOE) unit of FIG. 22;

FIG. 25A is a diagram illustrating a first irradiation pattern formed on the imaginary screen of FIG. 22;

FIG. 25B is a diagram illustrating a second irradiation pattern formed on the imaginary screen of FIG. 22;

FIG. 25C is a diagram illustrating a third irradiation pattern formed on the imaginary screen of FIG. 22;

FIG. 26 is a diagram of the composed irradiation patterns of FIGS. 25A, 25B and 25C;

FIG. 27A is a diagram illustrating a first modification of the light emitting unit and the DOE unit of FIG. 1; and

FIG. 27B is a diagram illustrating a second modification of the light emitting unit and the DOE unit of FIG. 1.

### DETAILED DESCRIPTION OF EXEMPLARY EMBODIMENTS

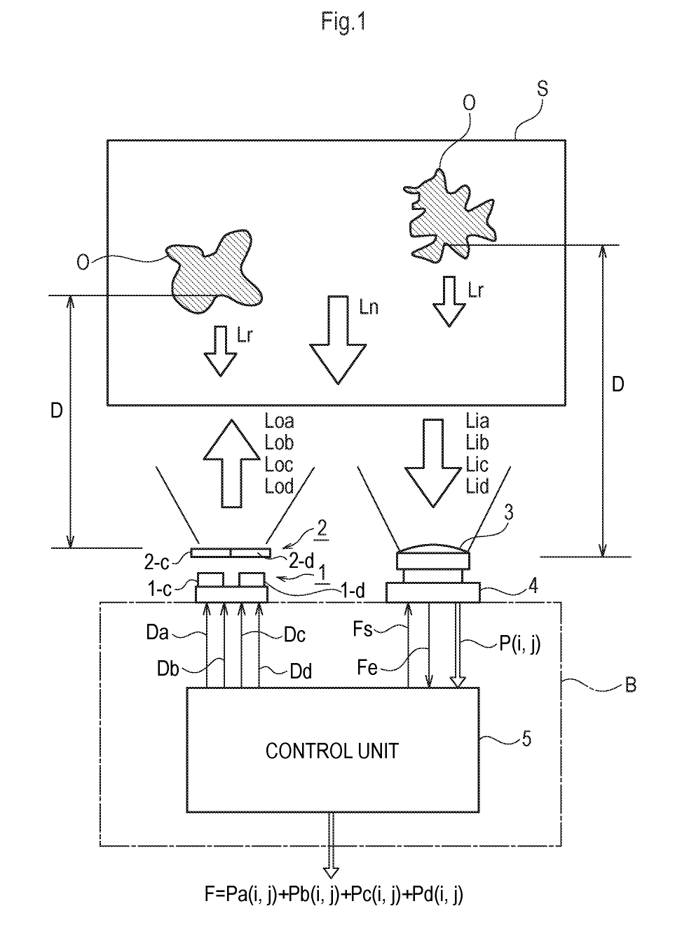

FIG. 1 is a diagram illustrating a first embodiment of the active image data generating apparatus according to the presently disclosed subject matter.

In FIG. 1, the image data generating apparatus is constructed by a light emitting unit 1, a diffractive optical element (DOE) unit 2 for receiving light from the light emitting unit 1 to time-divisionally generate irradiation pattern lights Lₒₐ, L_{ob}, L_{oc}, and L_{od} which are irradiated toward an image area which is defined as an imaginary screen S, a lens 3, and an image device 4 for time-divisionally receiving incident lights Lᵢₐ, L_{ib}, L_{ic} and L_{id} reflected from an object O on the imaginary screen S through the lens 3, and a control unit 5 for controlling the light emitting unit 1 and the image device 4. Note that the imaginary screen S is used for explaining the image regions; however, the imaginary screen S is actually absent. The control unit 5 is constructed by a microcomputer or the like which includes a control processing unit (CPU), a read-only memory or nonvolatile memory for storing programs and constants, a random-access memory (RAM) for storing temporary data, input/output interfaces, and so on.

In FIG. 1, the light emitting unit 1 associated with the DOE unit 2 and the image device 4 associated with the lens 3 are mounted on a body B, while the control unit 5 is provided within the body B.

Also, in FIG. 1, the incident lights Lᵢₐ, L_{ib}, L_{ic} and L_{id} include not only reflected light Lᵣ from the object O, but also background light (or noise light) Lₙ.

Further, in FIG. 1, D designates a distance between the image data generating apparatus and the object O.

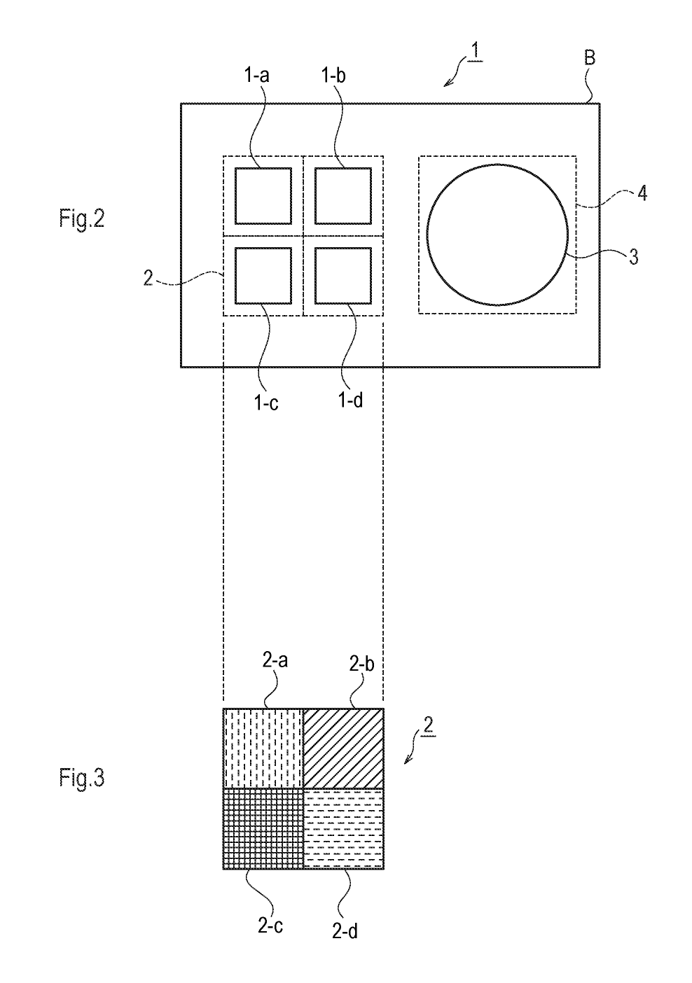

In FIG. 2, which is a top view of the image data generating apparatus of FIG. 1, the light emitting unit 1 is constructed by light emitting elements such as light-emitting diodes (LEDs) 1-a, 1-b, 1-c and 1-d arranged in a matrix of two rows and two columns. The LEDs 1-a, 1-b, 1-c and 1-d are driven by drive signals Dₐ, D_{b}, D_{c} and D_{d}, respectively, from the control unit 5 of FIG. 1. Note that the LEDs 1-a, 1-b, 1-c and 1-d generate visible light, infrared rays or the like.

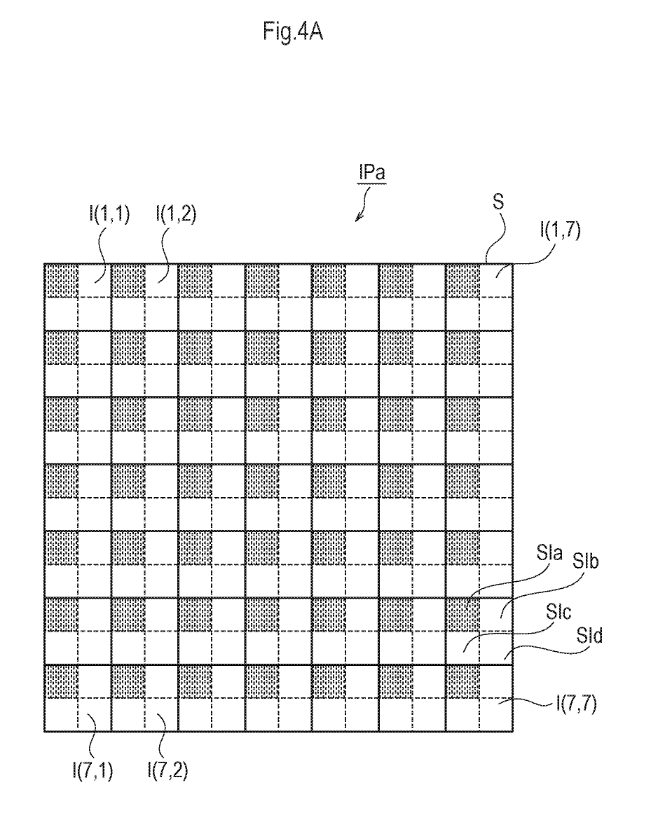

In FIG. 3, which is a top view of the DOE unit 2 of FIG. 1, the DOE unit 2 is constructed by DOEs 2-a, 2-b, 2-c and 2-d arranged in a matrix of two rows and two columns, each opposing the LEDs 1-a, 1-b, 1-c and 1-d, respectively.

Each of the DOEs 2-a, 2-b, 2-c and 2-d includes a pattern of diffractive lattices formed by the nano imprint technology. In this case, the diffractive lattice patterns of the DOEs 2-a, 2-b, 2-c and 2-d are different from each other, and do not overlap each other.

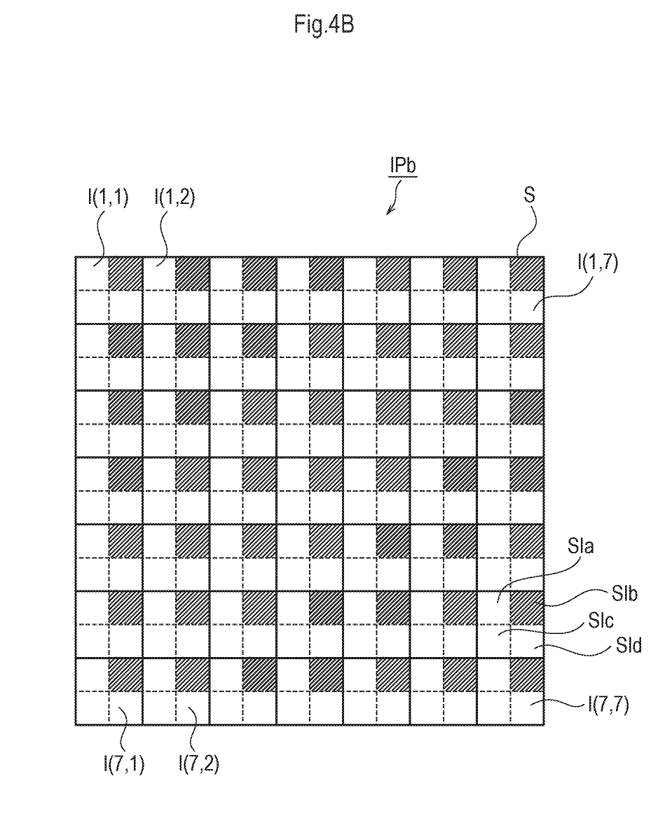

When the LED 1-a is turned on by the drive signal Dₐ, the DOE 2-a generates the irradiation pattern light Lₒₐ so that an irradiation pattern IPₐ as illustrated in FIG. 4A is formed on the imaginary screen S. In FIG. 4A, the imaginary screen S is divided into image regions I(i, j) (i=1, 2, . . . , 7; j=1, 2, . . . , 7) in a matrix of seven rows and seven columns, which correspond to pixels P(i, j) (i=1, 2, . . . , 7; j=1, 2, . . . , 7) of the image device 4 which will be explained later. Also, each of the image regions I(i, j) is divided into four square sub image regions SIₐ, SI_{b}, SI_{c} and SI_{d} in a matrix of two rows and two columns. In this case, the irradiation pattern IPₐ of FIG. 4A is formed by the sub image regions (first sub image group) SIₐ at upper-left positions (same positions) of the image regions I(i, j) (i=1, 2, . . . , 7; j=1, 2, . . . , 7).

When the LED 1-b is turned on by the drive signal D_{b}, the DOE 2-b generates the irradiation pattern light L_{ob} so that an irradiation pattern IP_{b} as illustrated in FIG. 4B is formed on the imaginary screen S. In this case, the irradiation pattern IP_{b} of FIG. 4B is formed by the sub image regions (second sub image group) SI_{b} at upper-right positions (same positions) of the image regions I(i, j) (i=1, 2, . . . , 7; j=1, 2, . . . , 7).

When the LED 1-c is turned on by the drive signal D, the DOE 2-c generates the irradiation pattern light L_{oc} so that an irradiation pattern IP_{c} as illustrated in FIG. 4C is formed on the imaginary screen S. In this case, the irradiation pattern IP_{c} of FIG. 4C is formed by the sub image regions (third sub image group) SI_{c} at lower-left positions (same positions) of the image regions I(i, j) (i=1, 2, . . . , 7; j=1, 2, . . . , 7).

When the LED 1-d is turned on by the drive signal D, the DOE 2-d generates the irradiation pattern light L_{od} so that an irradiation pattern IP_{d} as illustrated in FIG. 4D is formed on the imaginary screen S. In this case, the irradiation pattern IP_{d} of FIG. 4D is formed by the sub image regions (fourth sub image group) SI_{d} at lower-right positions (same positions) of the image regions I(i, j) (i=1, 2, . . . , 7; j=1, 2, . . . , 7).

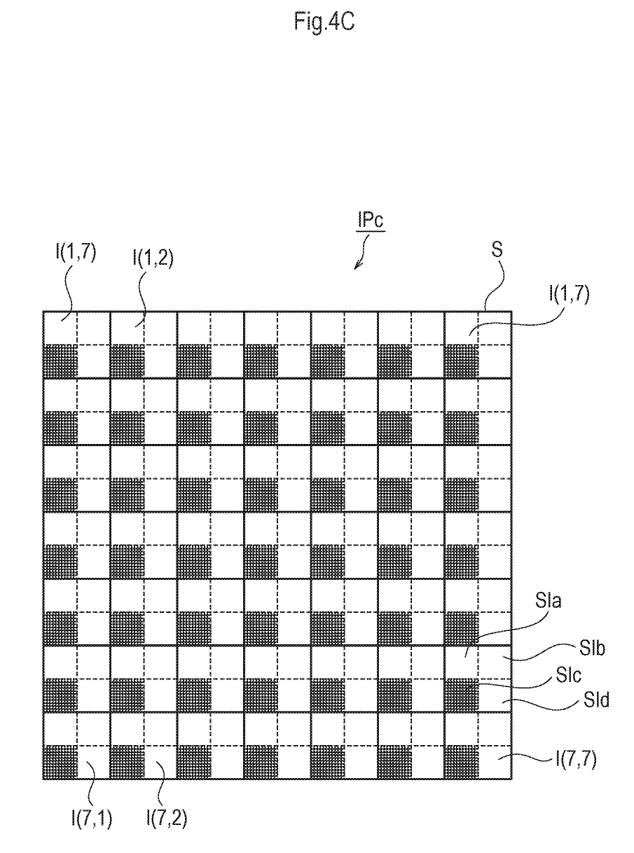

In FIG. 5, which is a detailed block circuit diagram of the image device 4 of FIG. 1, the image device 4 is constructed by a complementary metal oxide semiconductor (CMOS)-type image sensor, for example. Provided between row selection lines RL₁, RL₂, . . . , RL₇ and column selection lines CL₁, CL₂, . . . , CL₇ are pixels P(1,1), P(1,2), . . . , P(7, 7) each including one photodiode. Note that the image device 4 actually includes a large number of pixels such as 126×126 pixels; however, in order to simplify the description, only 7×7 pixels are illustrated in FIG. 5. Note that the image device 4 can be a charge-coupled device (CCD)-type image sensor.

One of the row selection lines RL₁, RL₂, . . . , RL₇ is selected by a row driver 41, while one of the column selection lines CL₁, CL₂, . . . , CL₇ is selected by a column driver 42. The row driver 41 and the column driver 42 are controlled by a control circuit 43, to select one of the pixels P(1, 1), P(1, 2), . . . , P(7, 7), so that analog pixel data P(1, 1), P(1, 2), . . . , or P(7,7) is outputted from the selected pixel to an analog-to-digital converter (ADC) 44 incorporating a correlated double sampling (CDS) circuit. Note that P(1,1), P(1,2), . . . , P(7,7) represent the analog or digital pixel data as well as the pixel per se. The control circuit 43 is controlled by the control unit 5 of FIG. 1. The digital pixel data P(i, j) of the analog-to-digital converter 44 is supplied to the control unit 5 of FIG. 1. In FIG. 5, a frame start signal Fₛ is supplied from the control unit 5 to the control circuit 43, and a frame end signal Fₑ is supplied from the control circuit 43 to the control unit 5.

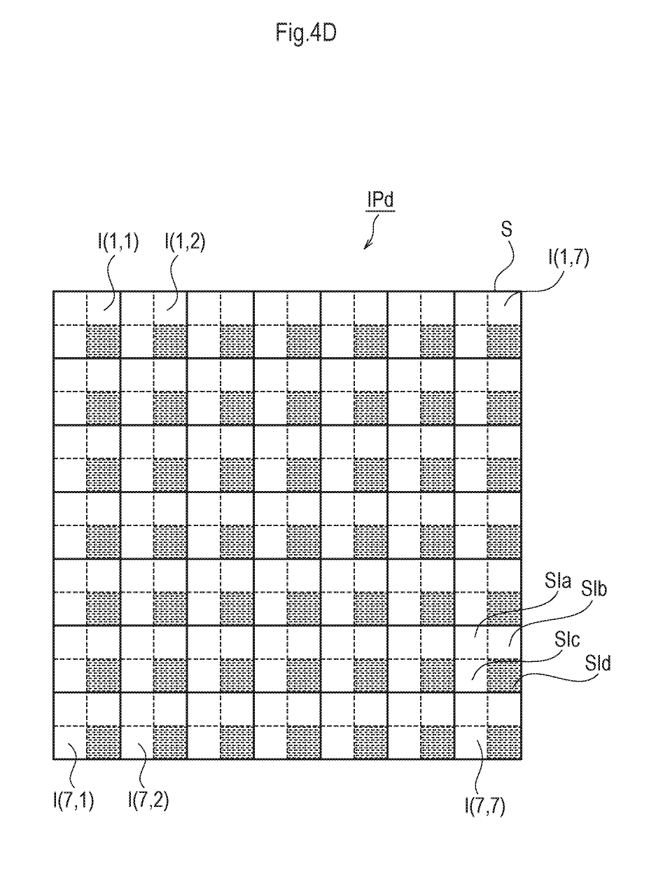

The operation of the control unit 5 of FIG. 1 is explained now with reference to FIG. 6. Note that, in order to simplify the description, assume that each of the irradiation patterns IPₐ, IP_{b}, IP_{c} and IP_{d} on the imaginary screen S is formed by 3×3 sub image regions, and the pixels P(i, j) of the image device 4 are arranged in three rows and three columns.

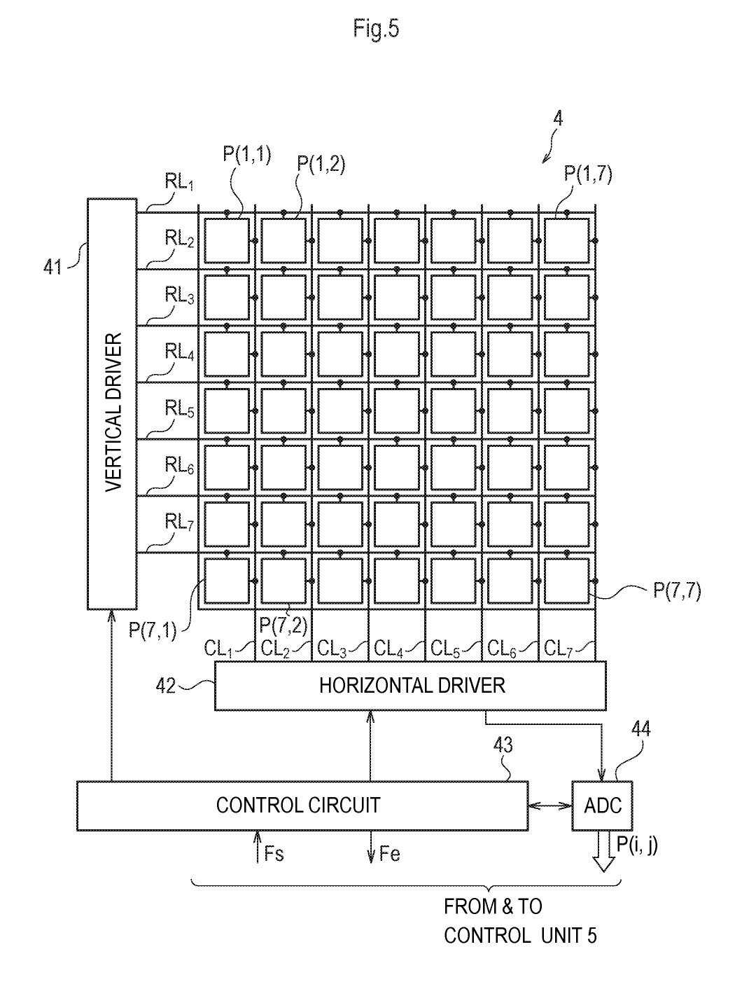

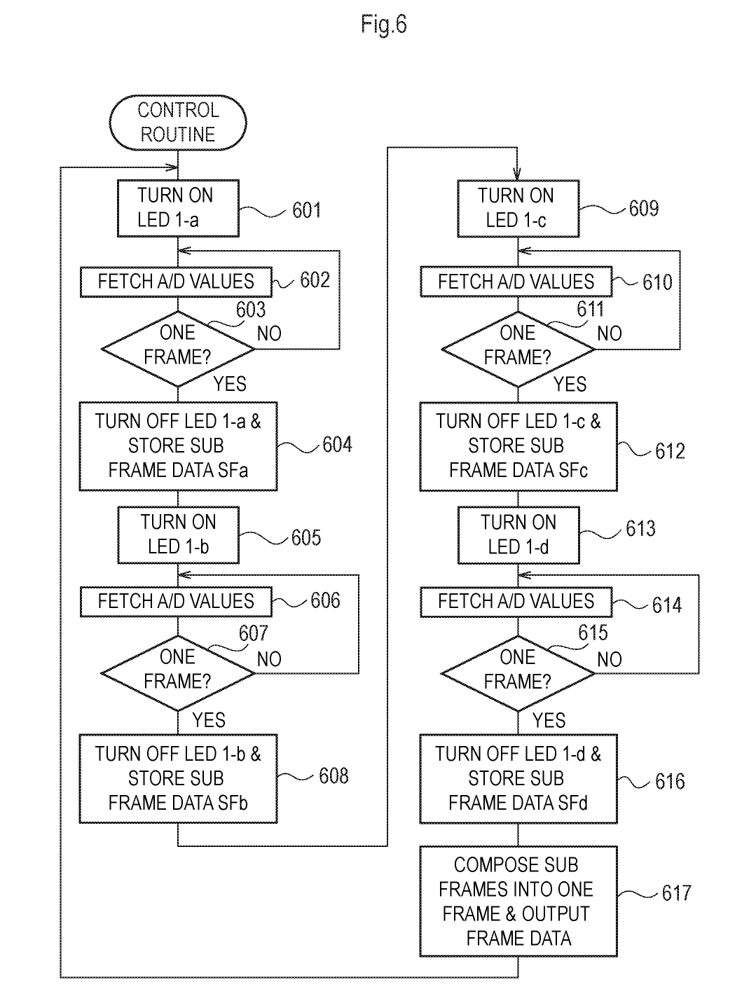

First, at step 601 (see timing t1 of FIG. 7), the control unit 5 generates a drive signal Dₐ to operate the LED 1-a. As a result, the imaginary screen S is irradiated with an irradiation pattern IPₐ as illustrated in FIG. 8A.

Next, at step 602, the control unit 5 generates a frame start signal Fₛ and transmits it to the image device 4 to fetch the digital pixel data P(1, 1), P(1, 2), . . . , P(7, 7) as sub pixel data Pₐ(1, 1), Pₐ(1, 2), . . . , Pₐ(7, 7). This fetching operation is continued by step 603 which determines whether or not a frame end signal Fₑ is received from the control circuit 43.

At step 604, the control unit 5 turns off the drive signal Dₐ to turn off the LED element 1-a. Also, the control unit 5 stores the following 3×3 fetched sub frame data SFₐ as illustrated in FIG. 8B in a first sub frame memory which is a part of the RAM:

Pₐ(1, 1), Pₐ(1, 2), Pₐ(1, 3);

Pₐ(2, 1), Pₐ(2, 2), Pₐ(2, 3); and

Pₐ(3, 1), Pₐ(3, 2), Pₐ(3, 3).

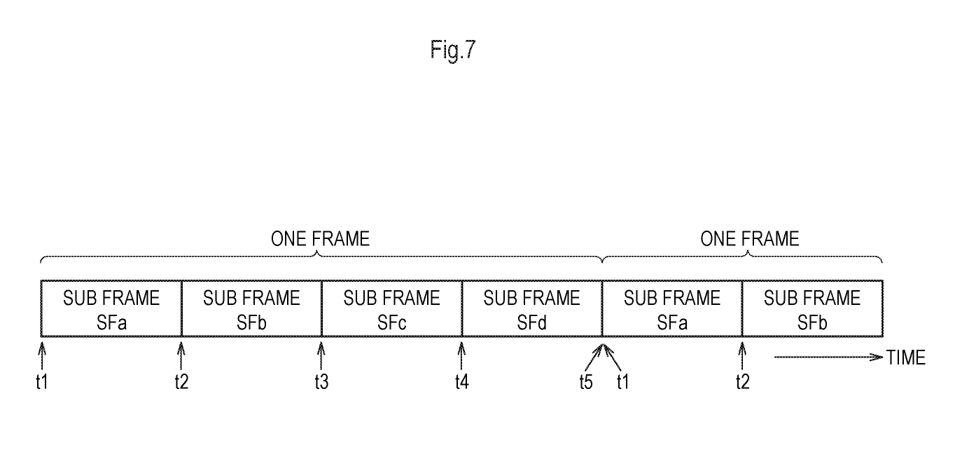

Next, at step 605 (see timing t2 of FIG. 7), the control unit 5 generates a drive signal D_{b} to operate the LED 1-b. As a result, the imaginary screen S is irradiated with an irradiation pattern IP_{b} as illustrated in FIG. 9A.

Next, at step 606, the control unit 5 generates a frame start signal Fₛ and transmits it to the image device 4 to fetch the digital pixel data P(1, 1), P(1, 2), . . . , P(7, 7) as sub pixel data P_{b}(1, 1), P_{b}(1, 2), . . . , P_{b}(7, 7). This fetching operation is continued by step 607 which determines whether or not a frame end signal Fₑ is received from the control circuit 43.

At step 608, the control unit 5 turns off the drive signal D_{b} to turn off the LED element 1-b. Also, the control unit 5 stores the following 3×3 fetched sub frame data SF_{b} as illustrated in FIG. 9B in a second sub frame memory which is a part of the RAM:

P_{b}(1, 1), P_{b}(1, 2), P_{b}(1, 3);

P_{b}(2, 1), P_{b}(2, 2), P_{b}(2, 3); and

P_{b}(3, 1), P_{b}(3, 2), P_{b}(3, 3).

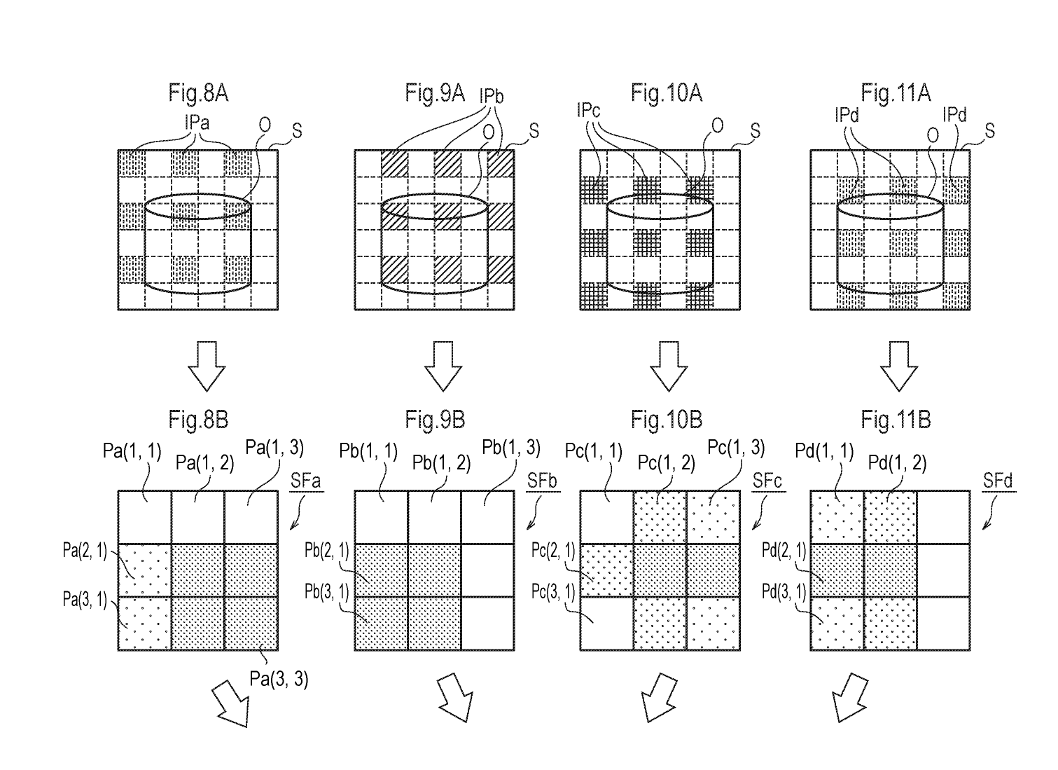

Next, at step 609 (see timing t3 of FIG. 7), the control unit 5 generates a drive signal D, to operate the LED 1-c. As a result, the imaginary screen S is irradiated with an irradiation pattern IP, as illustrated in FIG. 10A.

Next, at step 610, the control unit 5 generates a frame start signal Fₛ and transmits it to the image device 4 to fetch the digital pixel data P(1, 1), P(1, 2), . . . , P(7, 7) as sub pixel data P_{c}(1, 1), P_{c}(1, 2), . . . , P_{c}(7, 7). This fetching operation is continued by step 611 which determines whether or not a frame end signal Fₑ is received from the control circuit 43.

At step 612, the control unit 5 turns off the drive signal D, to turn off the LED element 1-c. Also, the control unit 5 stores the following 3×3 fetched sub frame data SF, as illustrated in FIG. 10B in a third sub frame memory which is a part of the RAM:

P_{c}(1, 1), P_{c}(1, 2), P_{c}(1, 3);

P_{c}(2, 1), P_{c}(2, 2), P_{c}(2, 3); and

P_{c}(3, 1), P_{c}(3, 2), P_{c}(3, 3).

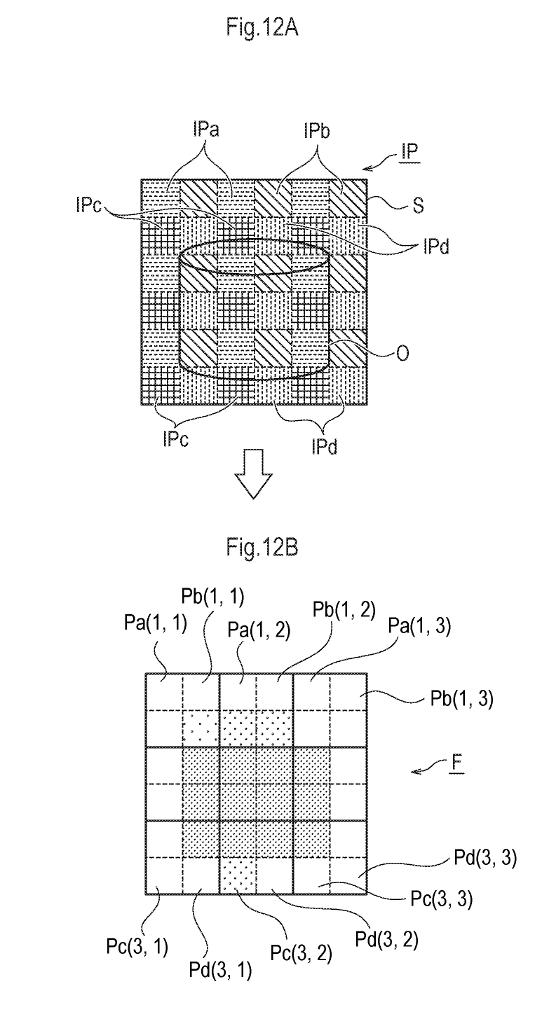

Next, at step 613 (see timing t4 of FIG. 7), the control unit 5 generates a drive signal D_{d} to operate the LED 1-d. As a result, the imaginary screen S is irradiated with an irradiation pattern IP_{d} as illustrated in FIG. 11A.

Next, at step 614, the control unit 5 generates a frame start signal Fₛ and transmits it to the image device 4 to fetch the digital pixel data P(1, 1), P(1, 2), . . . , P(7, 7) as sub pixel data P_{d}(1, 1), P_{d}(1, 2), . . . , P_{d}(7, 7). This fetching operation is continued by step 615 which determines whether or not a frame end signal Fₑ is received from the control circuit 43.

At step 616, the control unit 5 turns off the drive signal D_{d} to turn off the LED element 1-d. Also, the control unit 5 stores the following 3×3 fetched sub frame data SF_{d} as illustrated in FIG. 11B in a fourth sub frame memory which is a part of the RAM:

P_{d}(1, 1), P_{d}(1, 2), P_{d}(1, 3);

P_{d}(2, 1), P_{d}(2, 2), P_{d}(2, 3); and

P_{d}(3, 1), P_{d}(3, 2), P_{d}(3, 3).

Thus, the irradiating processes for the irradiation patterns IPₐ, IP_{b}, IP_{c}, and IP_{d} defined by the DOE elements 2-a, 2-b, 2-c and 2-d of the DOE unit 2 and their fetching processes for the sub pixel data Pₐ(i, j), P_{b}(i, j), P_{c}(i, j) and P_{d}(i, j) are time-divisionally carried out.

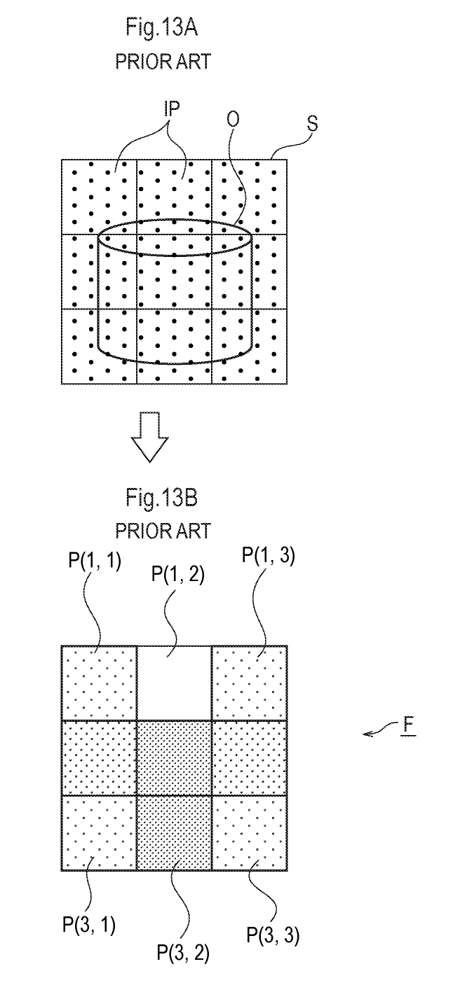

Next, at step 617 (see timing t5 of FIG. 7), the control unit 5 composes (or mixes) the sub frame data SFₐ, SF_{b}, SF_{c} and SF_{d} stored in the first, second, third and fourth sub frame memories corresponding to the composed irradiation patterns IPₐ, IP_{b}, IP_{c} and IP_{d} as illustrated in FIG. 12A into one frame F as illustrated in FIG. 12B. The frame data F is formed by the following 6×6 sub pixel data:

Pₐ(1, 1), P_{b}(1, 1), Pₐ(1, 2), P_{b}(1, 2), Pₐ(1, 3), P_{b}(1, 3);

P_{c}(1, 1), P_{d}(1, 1), P_{c}(1, 2), P_{d}(1, 2), P_{c}(1, 3), P_{d}(1, 3);

Pₐ(2, 1), P_{b}(2, 1), Pₐ(2, 2), P_{b}(2, 2), Pₐ(2, 3), P_{b}(2, 3);

P_{c}(2, 1), P_{d}(2, 1), P_{c}(2, 2), P_{d}(2, 2), P_{c}(2, 3), P_{d}(2, 3);

Pₐ(3, 1), P_{b}(3, 1), Pₐ(3, 2), P_{b}(3, 2), Pₐ(3, 3), P_{b}(3, 3);

P_{c}(3, 1), P_{d}(3, 1), P_{c}(3, 2), P_{d}(3, 2), P_{c}(3, 3), P_{d}(3, 3);

Pₐ(4, 1), P_{b}(4, 1), Pₐ(4, 2), P_{b}(4, 2), Pₐ(4, 3), P_{b}(4, 3); and

P_{c}(4, 1), P_{d}(4, 1), P_{c}(4, 2), P_{d}(4, 2), P_{c}(4, 3), P_{d}(4,3).

The frame data F formed by the 6×6 (=36) sub pixel data is outputted from the image data generating apparatus.

Then, the control returns to step 601, repeating the above-mentioned steps for another frame.

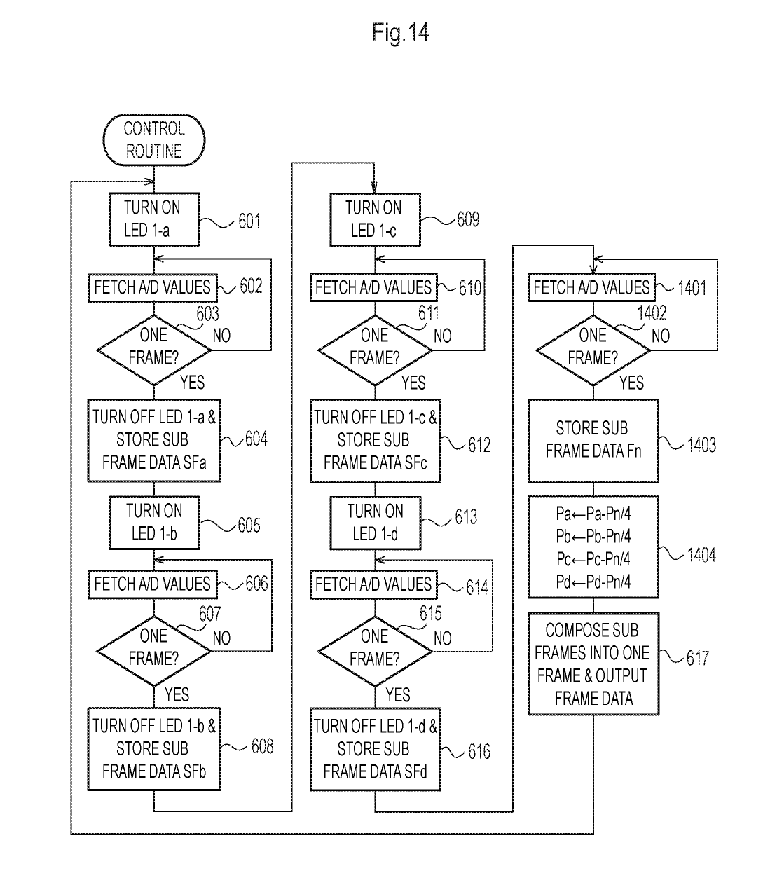

FIGS. 13A and 13B are diagrams for explaining the operation of the prior art image data generating apparatus.

As illustrated in FIG. 13A, the imaginary screen S is irradiated with an irradiation pattern IP. Also, as illustrated in FIG. 13B, a frame data F is formed by the following 3×3 (=9) pixel data:

P(1, 1), P(1, 2), P(1, 3);

P(2, 1), P(2, 2), P(2, 3); and

P(3, 1), P(3, 2), P(3, 3).

Thus, the resolution of the image data generating apparatus of FIG. 1 is four times (=36/9) that of the prior art image data generating apparatus, under the condition that the same image device is used.

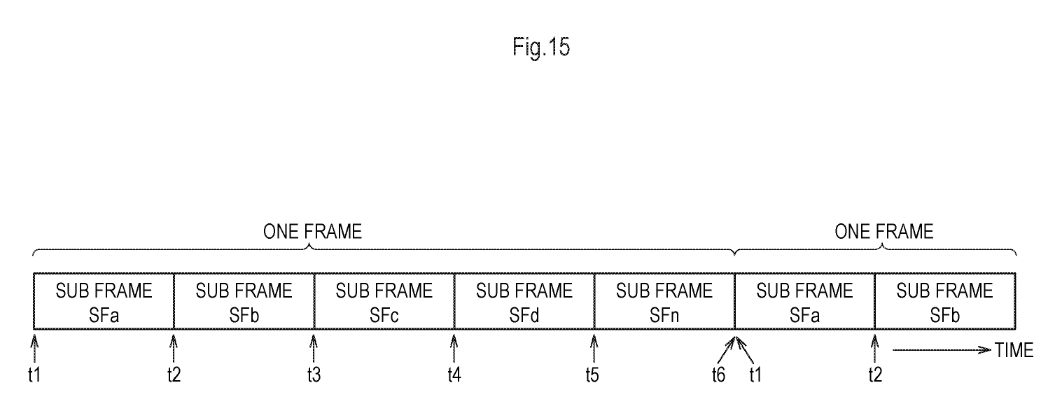

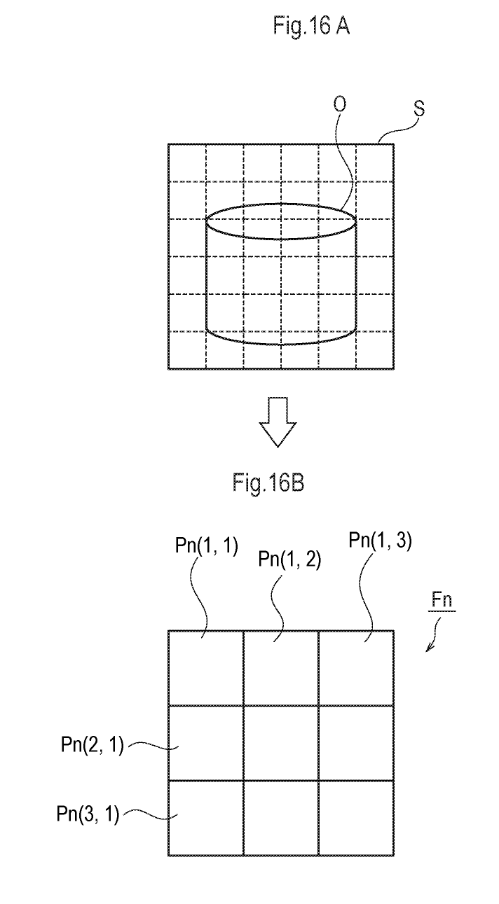

FIG. 14 is a modification of the flowchart of FIG. 6, steps 1401, 1402, 1403 and 1404 are added between steps 616 and 617 of FIG. 6. Note that FIG. 15 is a timing diagram for explaining the flowchart of FIG. 14.

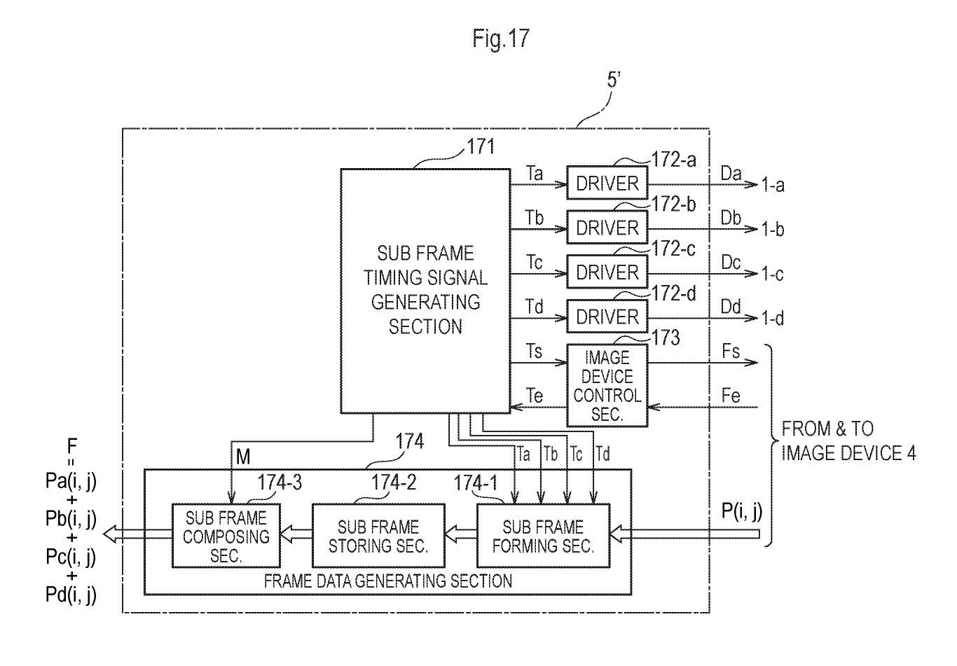

Before step 1401, all the LEDs 1-a, 1-b, 1-c and 1-d are turned off. In this state, the imaginary screen S is illustrated in FIG. 16A.

At step 1401, the control unit 5 generates a frame start signal Fₛ and transmits it to the image device 4 to fetch the digital pixel data P(1, 1), P(1, 2), . . . , P(7, 7) as background pixel data Pₙ(1, 1), Pₙ(1, 2), . . . , Pₙ(7, 7). This fetching operation is continued by step 1402 which determines whether or not a frame end signal Fₑ is received from the control circuit 43.

At step 1403, the control unit 5 stores the following 3×3 fetched background frame data Fₙ as illustrated in FIG. 16B in a fifth sub frame memory which is a part of the RAM:

Pₙ(1, 1), Pₙ(1, 2), Pₙ(1, 3);

Pₙ(2, 1), Pₙ(2, 2), Pₙ(2, 3); and

Pₙ(3, 1), Pₙ(3, 2), Pₙ(3, 3).

Next, at step 1404, the sub pixel data Pₐ(i, j), P_{b}(i, j), P_{c}(i, j) and P_{d}(i, j) are compensated for by the background pixel data Pₙ(i, j), i.e.,

Pₐ(i, j)←Pₐ(i, j)−Pₙ(i, j)/4

P_{b}(i, j)←P_{b}(i, j)−Pₙ(i, j)/4

P_{c}(i, j)←P_{c}(i, j)−Pₙ(i, j)/4

P_{d}(i, j)←P_{d}(i, j)−Pₙ(i, j)/4

In this case, the irradiation area of each of the sub pixel data Pₐ(i, j), P_{b}(i, j), P_{c}(i, j) and P_{d}(i, j) is one-fourth of that of the background pixel data Pₙ(i, j).

Then, the sub pixel data Pₐ(i, j), P_{b}(i, j), P_{c}(i, j) and P_{d}(i, j) are again stored in the first, second, third and fourth sub frame memories, respectively.

Then, the control proceeds to step 617.

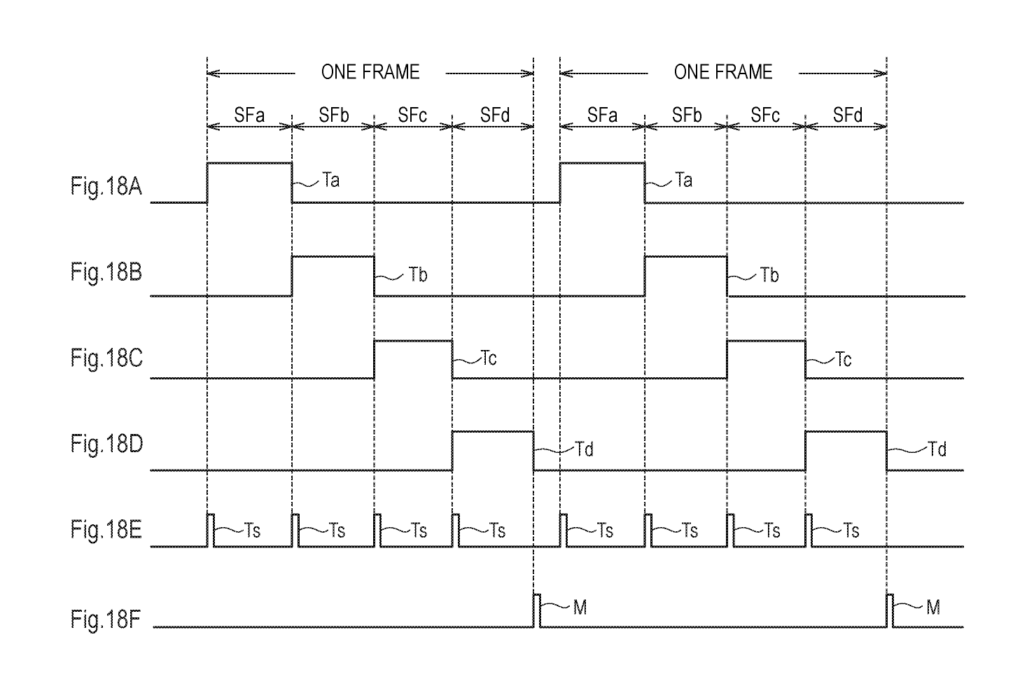

FIG. 17 is a detail block circuit diagram illustrating a first modification of the control unit 5 of FIG. 1.

In FIG. 17, a control unit 5′ is constructed by a sub frame timing signal generating section 171, drivers 172-a, 172-b, 172-c and 172-d for driving the LEDs 1-a, 1-b, 1-c and 1-d, respectively, an image device control section 173, and a frame data generating section 174. Also, the frame data generating section 174 is constructed by a sub frame forming section 174-1, a sub frame storing section 174-2 and a sub frame composing section 174-3. The sub frame timing signal generating section 171 can also be constructed by a microcomputer or the like.

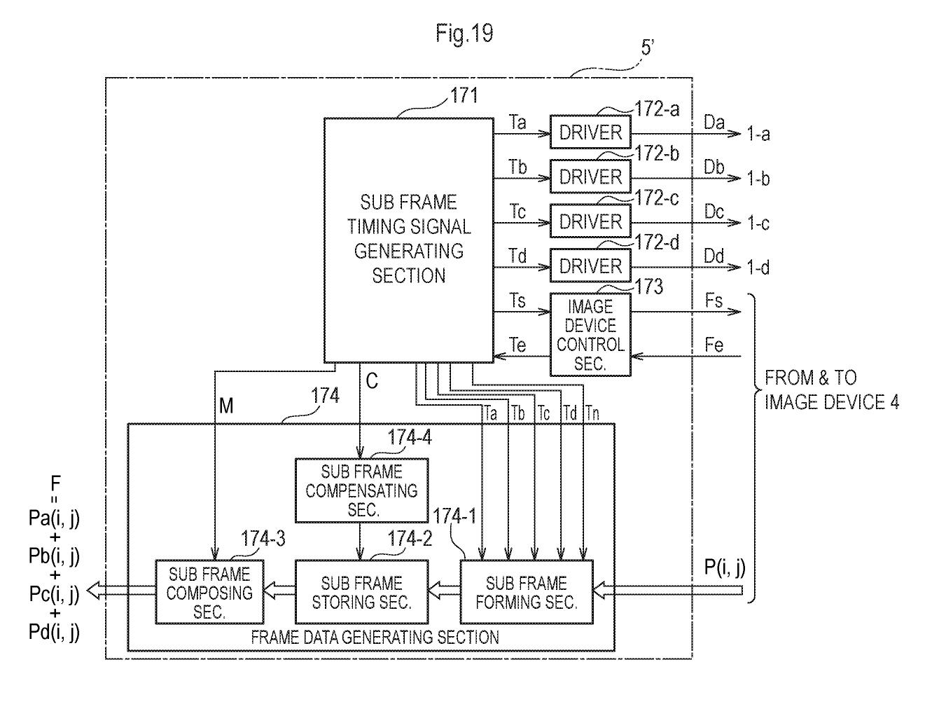

The sub frame timing signal generating section 171 time-divisionally generates timing signals Tₐ, T_{b}, T_{c} and T_{d} as illustrated in FIGS. 18A, 18B, 18C and 18D to define sub frame periods SFₐ, SF_{b}, SF_{c}, and SF_{d}, respectively. The timing signals Tₐ, T_{b}, T_{c}, and T_{d} are supplied to the drivers 172-a, 172-b, 172-c and 172-d, so that the LEDs 1-a, 1-b, 1-c and 1-d are sequentially turned on, and irradiation patterns IPₐ, IP_{b}, IP_{c}, and IP_{d} are sequentially irradiated on the imaginary screen S. Simultaneously, the sub frame timing signal generating section 171 generates an image device start timing signal Tₛ as illustrated in FIG. 18E and transmits it to the image device control section 173, so that the image device 4 is operated.

The timing signals Tₐ, T_{b}, T_{c}, and T_{d} are also supplied to the sub frame forming section 174-1. When the timing signal Tₐ is being received by the sub frame forming section 174-1, the sub frame forming section 174-1 receives pixel data P(i, j) from the image device 4 as sub pixel data Pₐ(i, j) to form a table of sub frame data SFₐ in the sub frame storing section 174-2. When the timing signal T_{b} is being received by the sub frame forming section 174-1, the sub frame forming section 174-1 receives pixel data P(i, j) from the image device 4 as sub pixel data P_{b}(i, j) to form a table of sub frame data SF_{b} in the sub frame storing section 174-2. When the timing signal T_{c} is being received by the sub frame forming section 174-1, the sub frame forming section 174-1 receives pixel data P(i, j) from the image device 4 as sub pixel data P_{c}(i, j) to form a table of sub frame data SF_{c} in the sub frame storing section 174-2. When the timing signal T_{d} is being received by the sub frame forming section 174-1, the sub frame forming section 174-1 receives sub pixel data P(i, j) from the image device 4 as sub pixel data P_{d}(i, j) to form a table of sub frame data SF_{d} in the sub frame storing section 174-2.

Finally, the sub frame timing signal generating section 171 generates a composing timing signal M as illustrated in FIG. 18F and transmits it to the sub frame composing section 174-3. As a result, the sub frame composing section 174-3 reads the sub frame data Pₐ(i, j), P_{b}(i, j), P_{c}(i, j) and P_{d}(i, j) from the first, second, third and fourth tables of the sub frame storing section 174-2 and composes them into one frame data F.

Thus, the operation of the control unit 5′ of FIG. 17 is the same as that of the flowchart of FIG. 6.

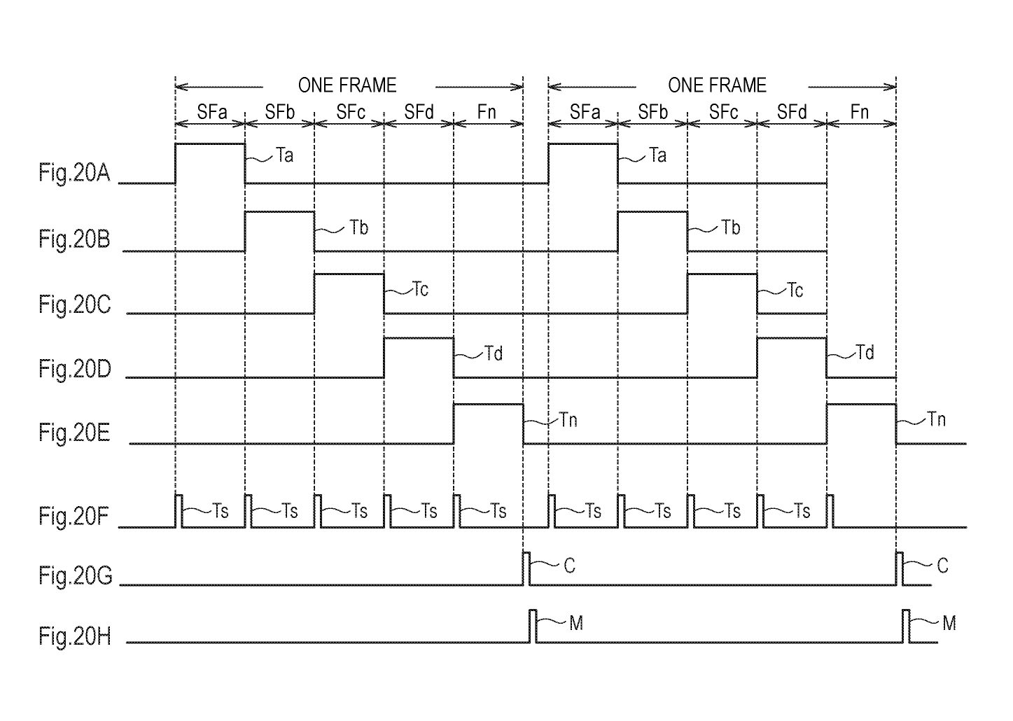

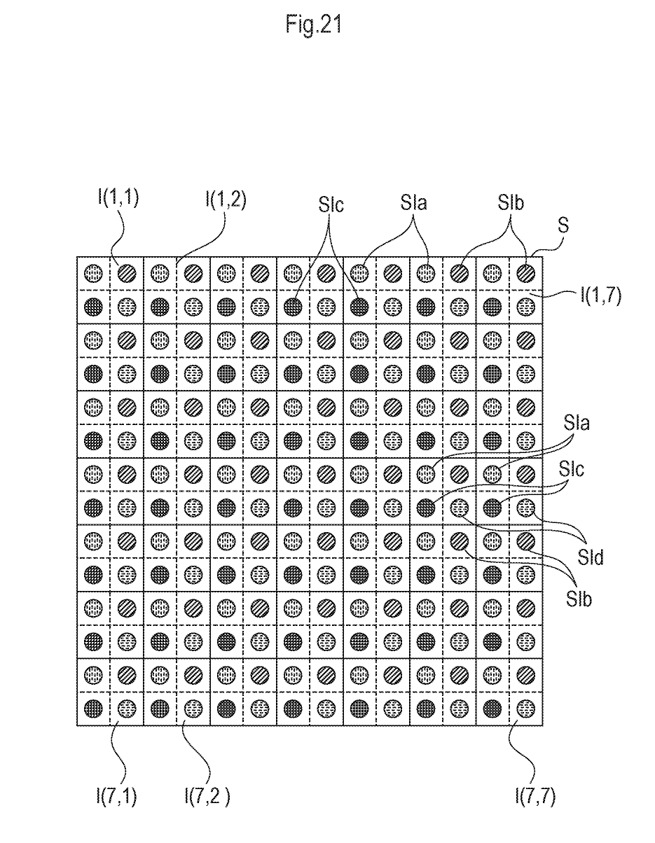

In FIG. 19, which is a second modification of the control unit 5 of FIG. 1, a sub frame compensating section 174-4 is added to the frame data forming section 174 of FIG. 17. The sub frame timing signal generating section 171 generates a timing signal T defining a frame period Fₙ as illustrated in FIG. 20E, after the timing signals Tₐ, T_{b}, T_{c} and T_{d}. The timing signal T is supplied to the sub frame forming section 174-1 without turning on the LEDs 1-a, 1-b, 1-c and 1-d, while the image device starting timing signal Tₛ is supplied to the image device control section 173 as illustrated in FIG. 20F. Therefore, the sub frame forming section 174-1 receives pixel data P(i, j) from the image device 4 as background frame data F in the sub frame storing section 174-2.

After the background pixel data table is completed, the sub frame timing signal generating section 171 generates a compensation timing signal C as illustrated in FIG. 20G and transmits it to the sub frame compensating section 174-4. The sub frame compensating section 174-4 compensates for the sub pixel data Pₐ(i, j), P_{b}(i, j), P_{c}(i, j) and P_{d}(i, j) in the first, second, third and fourth tables of the sub frame storing section 174-2 for by the background pixel data Pₙ(i, j), i.e.,

Pₐ(i, j)←Pₐ(i, j)−Pₙ(i, j)/4

P_{b}(i, j)←P_{b}(i, j)−Pₙ(i, j)/4

P_{c}(i, j)←P_{c}(i, j)−Pₙ(i, j)/4

P_{d}(i, j)←P_{d}(i, j)−Pₙ(i, j)/4

Then, the sub frame timing signal generating section 171 generates a composing timing signal M as illustrated in FIG. 20H and transmits it to the sub frame composing section 174-3, to perform a sub frame composing operation upon the compensated sub pixel data Pₐ(i, j), P_{b}(i, j), P_{c}(i, j) and P_{d}(i, j) in the first, second, third and fourth tables of the sub frame storing section 174-2.

Thus, the operation of the control unit 5′ of FIG. 19 is the same as that of the flowchart of FIG. 14.

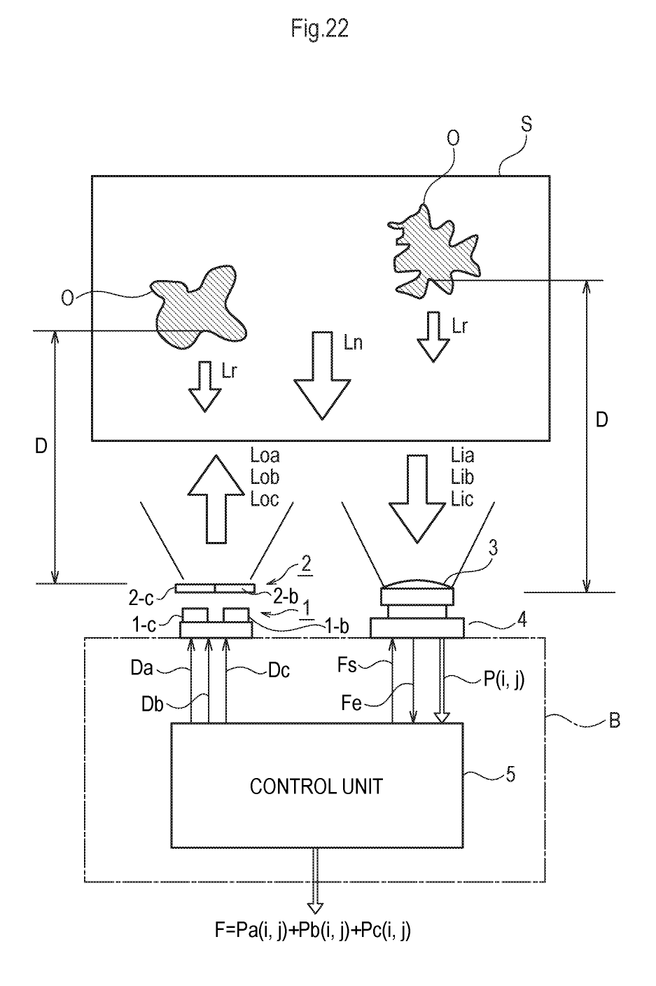

In the above-described first embodiment, the number of the sub image regions SIₐ, SI_{b}, SI_{c} and SI_{d} in each of the image regions I(i, j) is four; however, the number of the sub image regions can be 2, 3, 5 or more. In this case, the number of LEDs is also 2, 3, 5 or more, and the number of DOEs is 2, 3, 5 or more. Also, the sub image regions SIₐ, SI_{b}, SI_{c} and SI_{d} are square and are composed to each of the image regions I(i, j) (i=1, 2, . . . , 7; j=1, 2, . . . , 7); however, the sub image regions SIₐ, SI_{b}, SI_{c} and SI_{d} can be smaller circular spotshaped to conform to a smaller part of each of the image regions I(i, j) (i=1, 2, . . . , 7; j=1, 2, . . . , 7) as illustrated in FIG. 21. Even in this case, the image device 4 can be sufficiently operated.

Also, in the above-described first embodiment, after all the sub frame data SFₐ, SF_{b}, SF_{c} and SF_{d} are stored, a composing process is performed upon the all the sub frame data SFₐ, SF_{b}, SF_{c} and SF_{d} to form the frame data F; however, after the sub frame data SFₐ and SF_{b} are stored, a first composing process can be performed upon the sub frame data SFₐ and SF_{b} to form a first frame data, and after the sub frame data SF_{c} and SF_{d} are stored, a second composing process can be performed upon the sub frame data SF_{c} and SF_{d} to form a second frame data. Finally, a composing process can be performed upon the first and second frame data to form a final frame data, to thereby enhance the frame rate.

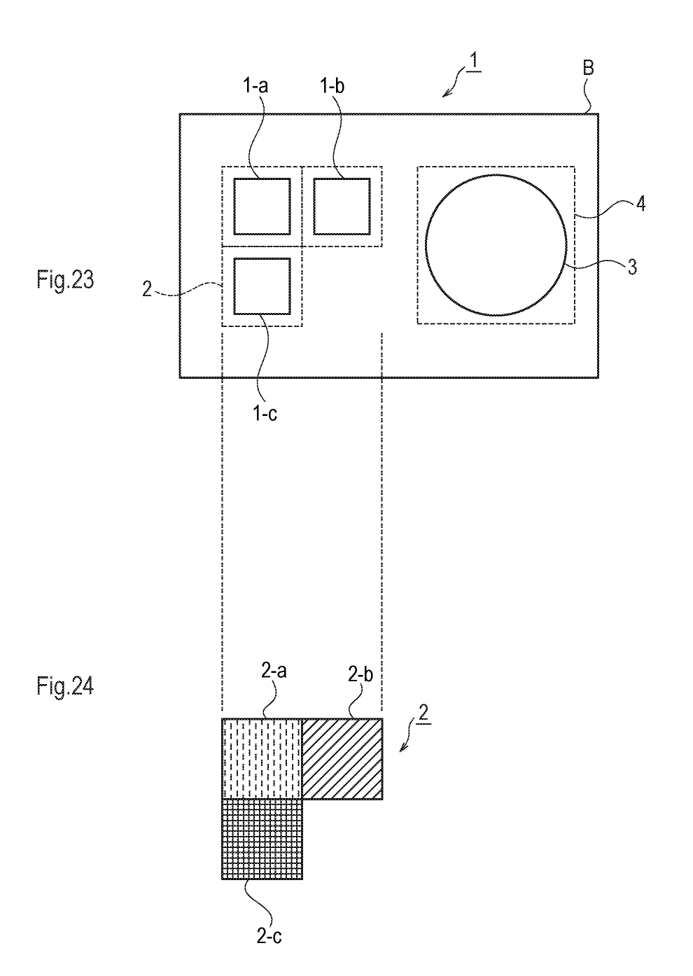

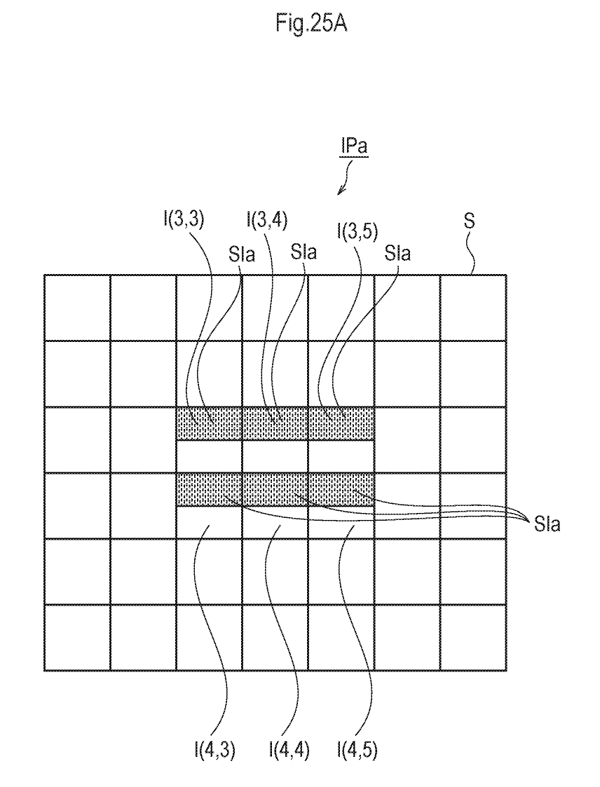

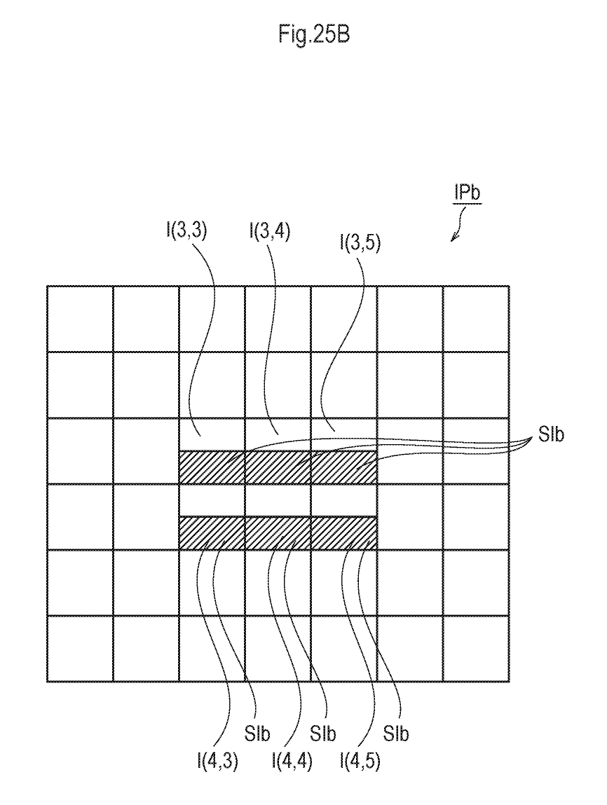

FIG. 22 is a diagram illustrating a second embodiment of the active image data generating apparatus according to the presently disclosed subject matter, FIG. 23 is a top view of the image data generating apparatus of FIG. 22, and FIG. 24 is a top view of the DOE unit 2 of FIG. 23.

In FIGS. 22, 23 and 24, the light emitting unit 1 is constructed by only LEDs 1-a, 1-b and 1-c, and the DOE unit 2 is constructed by only DOEs 2-a, 2-b and 2-c, each opposing the LEDs 1-a, 1-b and 1-c, respectively.

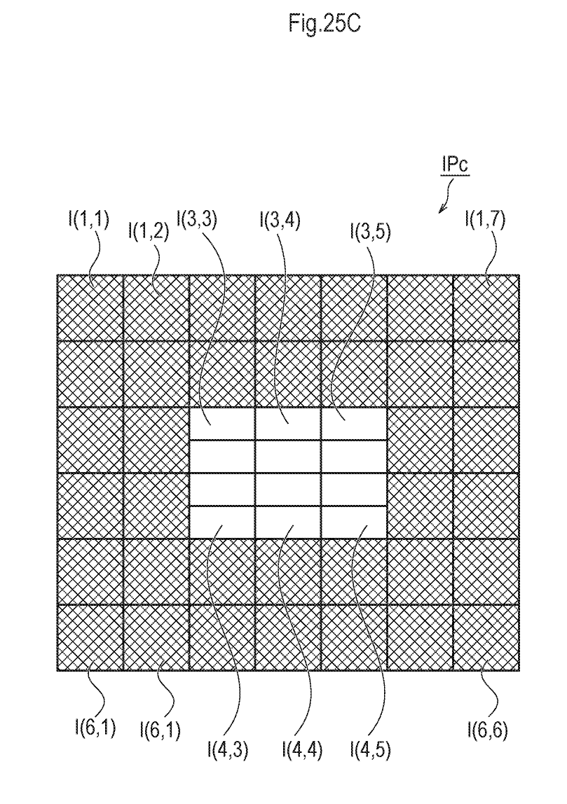

When the LED 1-a is turned on by the drive signal Dₐ, the DOE 2-a generates the irradiation pattern light Lₒₐ so that an irradiation pattern IPₐ as illustrated in FIG. 25A is formed on the imaginary screen S. In FIG. 25A, the imaginary screen S is divided into image regions I (i, j) (i=1, 2, . . . , 6; j=1, 2, . . . , 7) in a matrix of six rows and seven columns, which correspond to pixels P(i, j) (i=1, 2, . . . , 6; j=1, 2, . . . , 7). Also, each of the image regions I(3, 3), I(3, 4), I(3, 5), I(4, 3), I(4, 4) and I(4, 5) is divided into two rectangular sub image regions SIₐ and SI_{b}. In this case, the irradiation pattern IPₐ of FIG. 25A is formed by the sub image regions (first sub image group) SIₐ at upper positions (relatively same positions) of the image regions I(3, 3), I(3, 4), I(3, 5), I(4, 3), I(4, 4) and I(4, 5).

When the LED 1-b is turned on by the drive signal D_{b}, the DOE 2-b generates the irradiation pattern light L_{ob} so that an irradiation pattern IP_{b} as illustrated in FIG. 25B is formed on the imaginary screen S. In this case, the irradiation pattern IP_{b} of FIG. 25B is formed by the sub image regions (second sub image group) SI_{b} at lower positions (relatively same positions) of the image regions I(3, 3), I(3, 4), I(3, 5), I(4, 3), I(4, 4) and I(4, 5).

When the LED 1-c is turned on by the drive signal D_{c}, the DOE 2-c generates the irradiation pattern light L_{oc} so that an irradiation pattern IP, as illustrated in FIG. 25C is formed on the imaginary screen S. In this case, the irradiation pattern IP_{c} of FIG. 25C is formed by the image regions (image group) I(1, 1), I(1, 2), . . . , I(7, 7); I(2, 1), I(2, 2), . . . , I(2, 7); I(3, 1), I(3, 2), I(3, 6), I(3, 7); I(4, 1), I(4, 2), I(4, 6), I(4, 7); I(5, 1), I(5, 2), . . . , I(5, 7); I(6, 1), I(6, 2), . . . , I(6, 7).

The operation of the control unit 5 of FIG. 22 is carried out in accordance with the flowchart of FIG. 6 except that steps 613 to 616 are deleted.

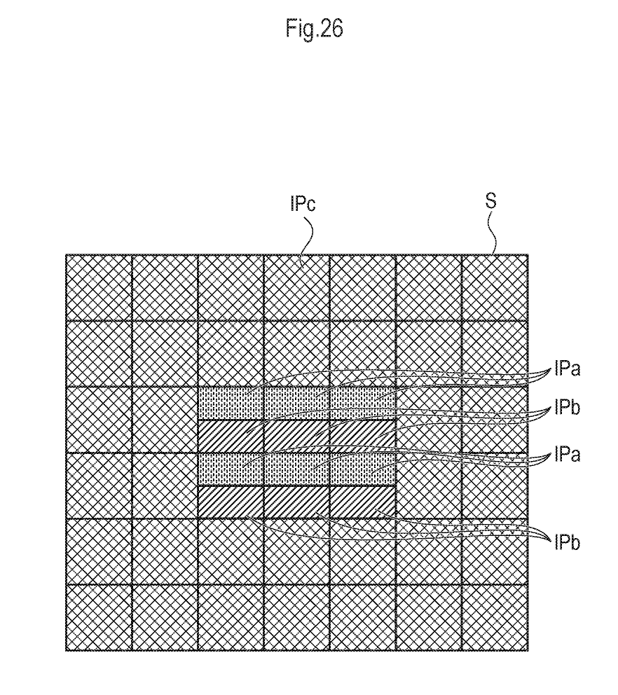

That is, in accordance with the irradiation patterns IPₐ, IP_{b} and IP_{c} defined by the DOE elements 2-a, 2-b and 2-c of the DOE unit 2 as illustrated in FIG. 26, a composing process is carried out to form one frame data F:

P_{c}(1, 1), P_{c}(1, 2), . . . , P_{c}(1, 7);

P_{c}(2, 1), P_{c}(2, 2), . . . , P_{c}(2, 7);

P_{c}(3, 1), P_{c}(3, 2), Pₐ(3, 3)/P_{b}(3, 3), Pₐ(3, 4)/P_{b}(3, 4), Pₐ(3, 5), P_{b}(3, 5), P_{c}(3, 6), P_{c}(3, 7);

P_{c}(4, 1), P_{c}(4, 2), Pₐ(4, 3)/P_{b}(4, 3), Pₐ(4, 4)/P_{b}(4, 4), Pₐ(4, 5)/P_{b}(4, 5), P_{c}(4, 6), P_{c}(4, 7);

P_{c}(5, 1), P_{c}(5, 2), . . . , P_{c}(5, 7); and

P_{c}(6, 1), P_{c}(6, 2), . . . , P_{c}(6, 7).

where Pₐ(3, 3), Pₐ(3, 4), Pₐ(3, 5), Pₐ(4, 3), Pₐ(4, 4), Pₐ(4, 5), P_{b}(3, 3), P_{b}(3, 4), P_{b}(3, 5), P_{b}(4, 3), P_{b}(4, 4) and P_{b}(4, 5) are sub pixel data, and P_{c}(1, 1), P_{c}(1, 2), . . . , P_{c}(6, 7) are pixel data.

Thus, the resolution of the inner center port ion on the imaginary screen S is twice that of the prior art image data generating apparatus, while the resolution of the peripheral portion on the imaginary screen S is maintained at the same level of the prior art image data generating apparatus.

The operation of the control unit 5 of FIG. 22 is also carried out in accordance with the flowchart of FIG. 14 except that steps 613 to 616 are deleted. In this case, the sub pixel data Pₐ(i, j) and P_{b}(i, j) are compensated for by the background pixel data Pₐ(i, j), i.e.,

Pₐ(i, i)←Pₐ(i, j)−Pₙ(i, j)/2

P_{b}(i, j)←P_{b}(i, j)−Pₙ(i, j)/2

In this case, the irradiation area of each of the sub pixel data Pₐ(i, j) and P_{b}(i, j) is half of that of the background pixel data Pₐ(i, j).

Also, the pixel data P_{c}(i, j) are compensated for by the background pixel data Pₐ(i, j), i.e.,

P_{c}(i, j)←P_{c}(i, j)−Pₙ(i, j)

The control unit 5 of FIG. 22 can be constructed by the control unit 5′ of FIG. 17 or 19 except that the timing signal T_{d} and the driver 172-d are deleted.

The image data generating apparatus according to the presently disclosed subject matter can be applied to a distance measuring apparatus for measuring the distance D between the image data generating apparatus and the object O. In this case, other light receiving elements such as photodiodes and an indirect time-of-flight (TOF) type phase-difference detecting circuit are added. The indirect TOF type phase-difference detecting circuit is operated to detect phase-differences the drive signals Dₐ, D_{b}, Dₐ and D_{d} of the irradiation pattern lights Lₒₐ, L_{ob}, L_{oc} and L_{od} and light receiving signals of incident lights Lᵢₐ, L_{ib}, L_{ic} and L_{id} by the light receiving elements. The distance information obtained from the indirect DOF type phase-difference detecting circuit is used for identifying the three-dimensional object and tracking the object.

In the above-described second embodiment, each of the image regions on the inner center portion of the imaginary screen S are divided into sub image regions, while the image regions on the peripheral portion of the imaginary screen S are not divided into sub image regions. However, each of the image regions on the peripheral portion of the imaginary screen S can be divided into sub image regions. In this case, the number of sub image regions per one image region on the inner center portion is larger than that of sub image regions per one image region on the peripheral portion.

In the above-described embodiments, image regions are divided into four or two sub image regions; however, such image regions can be three, five or more sub image regions.

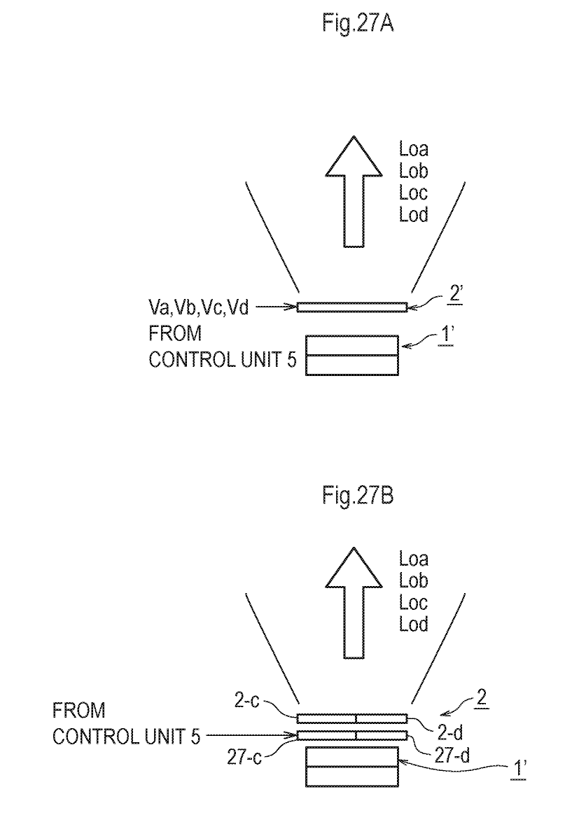

Also, in the above-described embodiments, the light emitting unit 1 is formed by four or three LEDs, and the DOE unit 2 is also formed by four or three DOEs. However, as illustrated in FIG. 27A, a single variable DOE 2′ is provided and controlled by its applied voltage Vₐ, V_{b}, V, or V_{d} from the control unit 5 and/or temperature to change the diffractive lattice pattern or irradiation pattern. Therefore, if the DOE unit is constructed by such a variable DOE 2′, the number of LEDs of the light emitting unit 1′ can be one and the number of DOEs in the DOE unit can be one.

Further, in the above-described embodiments, as illustrated in FIG. 27B, the number of LEDs of the light emitting unit 1′ can be one, and multiple mechanical shutters 27-a, 27-b, 27-c and 27-d can be provided between the light emitting unit 1′ and each of the DOEs 2-a, 2-b, 2-c and 2-d of the DOE unit 2. In this case, while the only one LED is turned on, the mechanical shutters are sequentially opened by the control unit 5, so that the DOEs can generate multiple irradiation patterns.

Still further, the LEDs can be replaced by laser diodes (LDs).

It will be apparent to those skilled in the art that various modifications and variations can be made in the presently disclosed subject matter without departing from the spirit or scope of the presently disclosed subject matter. Thus, it is intended that the presently disclosed subject matter covers the modifications and variations of the presently disclosed subject matter provided they come within the scope of the appended claims and their equivalents. All related or prior art references described above and in the Background section of the present specification are hereby incorporated in their entirety by reference.

1. An active image data generating apparatus comprising:
a light emitting unit adapted to emit irradiation light;
an image device having multiple pixels;
a diffractive optical element unit adapted to receive said irradiation light from said light emitting unit to generate multiple irradiation patterns toward an image area, said image area being divided into multiple image regions each corresponding to one of said multiple pixels, each of said image regions being divided into multiple sub image regions, said sub image regions located at same positions within said image regions being defined as one of sub image region groups; and
a control unit adapted to operate said light emitting unit and said image device to time-divisionally irradiate said sub image region groups with said irradiation patterns, respectively, to fetch multiple sub frame data from all the pixels of said image device, and to compose said multiple sub frame data into frame data of said image area.

2. The active image data generating apparatus as set forth in claim 1, wherein said control unit comprises:
a sub frame storing section;
a sub frame forming section adapted to receive said multiple sub frame data from said image device and store said multiple sub frame data in said sub frame storing section; and
a sub frame composing section adapted to compose said multiple sub frame data in said frame storing section into said frame data.

3. The active image data generating apparatus as set forth in claim 1, wherein said control unit is adapted to fetch background sub frame data from all the pixels of said image device without operating said light emitting unit, and
wherein said control unit further comprises a sub frame compensating section adapted to compensate for said multiple sub frame data by subtracting said background sub frame data from said multiple sub frame data.

4. The active image data generating apparatus as set forth in claim 1, wherein said light emitting unit comprises multiple light emitting elements each for one of said irradiation patterns, and
wherein said diffractive optical element unit comprises multiple diffractive optical elements each for one of said irradiation patterns.

5. The active image data generating apparatus as set forth in claim 1, wherein said light emitting unit comprises a single light emitting element, and
wherein said diffractive optical element unit comprises a single variable diffractive optical element controlled by said control unit.

6. The active image data generating apparatus as set forth in claim 1, wherein said light emitting unit comprises a single light emitting element, and
wherein said diffractive optical element unit comprises multiple diffractive optical elements each for one of said irradiation patterns,
said active image data generating apparatus further comprising multiple mechanical shutters provided between said single light emitting element and said multiple diffractive optical elements, said mechanical shutters being controlled by said control unit.

7. The active image data generating apparatus as set forth in claim 1, wherein said sub image regions are square, rectangular or spot-shaped.

8. An active image data generating apparatus comprising:
a light emitting unit adapted to emit irradiation light;
an image device having multiple pixels;
a diffractive optical element unit adapted to receive said irradiation light from said light emitting unit to generate multiple irradiation patterns toward an image area, said image area being divided into multiple image regions each corresponding to one of said multiple pixels, each of first ones of said image regions being divided into multiple sub image regions, said first sub image regions located at same positions within said first image regions being defined as one of sub image region groups, second ones of said image regions being defined as an image region group; and
a control unit adapted to operate said light emitting unit and said image device to time-divisionally irradiate said sub image region groups and said image region group with said irradiation patterns, respectively, to fetch multiple sub frame data from all the pixels of said image device, and to compose said multiple sub frame data into frame data of said image area.

9. The active image data generating apparatus as set forth in claim 8, wherein said first image regions are located at an inner center portion of said image area, and said second image regions are located at a peripheral portion of said image area surrounding said inner center portion.

10. The active image data generating apparatus as set forth in claim 8, wherein said control unit comprises:
a sub frame storing section;
a sub frame forming section adapted to receive said multiple sub frame data from said image device and store said multiple sub frame data in said sub frame storing section; and
a sub frame composing section adapted to compose said multiple sub frame data in said frame storing section into said frame data.

11. The active image data generating apparatus as set forth in claim 8, wherein said control unit is adapted to fetch background sub frame data from all the pixels of said image device without operating said light emitting unit, and
wherein said control unit further comprises a sub frame compensating section adapted to compensate for said multiple sub frame data by subtracting said background sub frame data from said multiple sub frame data.

12. The active image data generating apparatus as set forth in claim 8, wherein said light emitting unit comprises multiple light emitting elements each for one of said irradiation patterns, and
wherein said diffractive optical element unit comprises multiple diffractive optical elements each for one of said irradiation patterns.

13. The active image data generating apparatus as set forth in claim 8, wherein said light emitting unit comprises a single light emitting element, and
wherein said diffractive optical element unit comprises a single variable diffractive optical element controlled by said control unit.

14. The active image data generating apparatus as set forth in claim 8, wherein said light emitting unit comprises a single light emitting element, and
wherein said diffractive optical element unit comprises multiple diffractive optical elements each for one of said irradiation patterns,
said active image data generating apparatus further comprising multiple mechanical shutters provided between said single light emitting element and said multiple diffractive optical elements, said mechanical shutters being controlled by said control unit.

15. The active image data generating apparatus as set forth in claim 8, wherein said sub image regions are square, rectangular or spotshaped.

16. An active image data generating apparatus comprising:
a light emitting unit adapted to emit irradiation light;
an image device having multiple pixels;
a diffractive optical element unit adapted to receive said irradiation light from said light emitting unit to generate multiple irradiation patterns toward an image area, said image area being divided into multiple image regions each corresponding to one of said multiple pixels, each of first ones of said image regions being divided into multiple first sub image regions, said first sub image regions located at same positions within said first image regions being defined as one of first sub image region groups, each of second ones of said image regions being divided into multiple second sub image regions, said second sub image regions locating at relatively same positions within said second image regions being defined as one of second sub image region groups; and
a control unit adapted to operate said light emitting unit and said image device to time-divisionally irradiate said first and second sub image region groups with said irradiation patterns, respectively, to fetch multiple sub frame data from all the pixels of said image device, and to compose said multiple sub frame data into frame data of said image area.

17. The active image data generating apparatus as set forth in claim 16, wherein said first image regions are located at an inner center portion of said image area, and said second image regions are located at a peripheral portion of said image area surrounding said inner center portion.

18. The active image data generating apparatus as set forth in claim 16, wherein said control unit is adapted to fetch background sub frame data from all the pixels of said image device without operating said light emitting unit, and
wherein said control unit further comprises a sub frame compensating section adapted to compensate for said multiple sub frame data by subtracting said background sub frame data from said multiple sub frame data.
